(19) United States
(12) Patent Application Publication
(10) Pub. No.: US 2009/0056226 A1
(43) Pub. Date: Mar. 5, 2009

(54) Rotating shaft of louver blade for shutter assembly

(75) Inventors: De-Jun Zhang, Guangdong Province (CN); Daniel Yang, Guangdong Province (CN)

Correspondence Address: BIRCH STEWART KOLASCH & BIRCH, PO BOX 747, FALLS CHURCH, VA, 22040-0747, US

(73) Assignee: NIEN MADE ENTERPRISE CO., LTD

(21) Appl. No.: 11/896,080

(22) Filed: Aug. 29, 2007

(51) Int. Cl. E06B 7/08

(52) U.S. Cl. 49/74.1

(57) ABSTRACT

A rotating shaft of louver blades for shutter assembly interconnected between a louver blade and a frame is provided, which includes a bushing and a shaft. A body of the bushing has a through hole and a plurality of slots, such that the body can be deformed flexibly. A front section of the shaft is fitted with the through hole. After the bushing is combined with the frame, the fixing hole is relatively small, which forces the end of the bushing having the slots to be compressed inwards, and after the front section passes through the bushing, the flexibly-deformed portion is expanded outwards, such that the bushing can be engaged with the frame. Moreover, the flexibly-deformed portion of the bushing generates a clipping force to the front section, such that the shaft and bushing are tightly fitted with each other, thereby making the louver blade be easily rotated and positioned.

### BACKGROUND OF THE INVENTION

1. Field of the Invention

The present invention relates to a technical field of a pivoting structure of louver blades for a shutter assembly, and more particularly to a rotating shaft of a shutter assembly, capable of making the bushing be firmly snapped within a frame, such that the louver blades can be easily rotated and positioned.

2. Related Art

Generally, in a shutter assembly or a louver, a rotating shaft is pivoted therebetween each louver blade and a frame, such that the louver blade can be pivotally rotated with respect to the frame, so as to readily change the angle of the slats opening from closed position.

For example, in P.R.China Published Patent No. 2,525,224Y, entitled “Louver blade positioning structure for shutter assembly”, a technique is disclosed as shown in FIG. 6, in which the positioning structure includes a penetrating shaft 71 and a bushing 72. The bushing 72 is formed of a frame 721 and a shaft barrel 722. An outer diameter of the frame 721 is greater than that of the shaft barrel 722. The outer diameter of the shaft barrel 722 is approximately equal to an aperture of a fixing hole 731 of a frame 73 for the shutter assembly, such that the shaft barrel 722 can be inserted into the fixing hole 731. A plurality of ribs 723 is formed between the frame 721 and the shaft barrel 722, such that the shaft barrel 722 can be snapped and positioned into the fixing hole 731 through the ribs 723 once being inserted within the fixing hole 731 of the frame 73. The penetrating shaft 71 has a front section 711, a middle section 712, and a rear section 713. An outer diameter of the middle section 712 is approximately equal to an inner diameter of the shaft barrel 722, such that the middle section 712 can be firmly fitted with the shaft barrel 722 once being inserted into the shaft barrel 722. An outer diameter of the rear section 713 is greater than that of the middle section 712, such that when the middle section 712 is inserted in the shaft barrel 722, the rear section 713 is stopped against an end surface of the shaft barrel 722. An outer diameter of the front section 711 is smaller than that of the middle section 712, and a plurality of ribs 714 is also formed between the front section 711 and the middle section 712, such that the middle section 712 is snapped and positioned into a fixing hole 741 of the louver blade 74 through the ribs 714 once being inserted into the fixing hole 741.

In the above positioning structure, the penetrating shaft 71 must penetrate from an end of the bushing 72 first and thusly, subsequently combined the penetrating shaft 71 with the bushing 72, and then, the shaft barrel 722 of the bushing 72 can be inserted into the fixing hole 731 of the frame 73 for being snapped and positioned therein. However, since the shaft barrel 722 is a cylindrical-shaped structure, the fixing hole 731 in the frame 73 must be processed into a configuration similar to the outer diameter of the shaft barrel 722, so as to allow the shaft barrel 722 to be readily inserted into the fixing hole 731.

If the aperture of the fixing hole 731 is too small, the shaft barrel 722 cannot be easily inserted into the fixing hole 731, and if the shaft barrel 722 is forced to be inserted into the fixing hole 731, the shaft barrel 722 may be deformed, and an over-tight interfitting friction occurs between the shaft barrel 722 and the middle section 712 of the penetrating shaft 71, as a result, the penetrating shaft 71 and the louver blade 74 cannot be easily rotated, thereby influencing the convenience of the rotating operation of the louver blade 74. On the contrary, if the aperture of the fixing hole 731 is relatively large, though the shaft barrel 722 can be easily inserted into the fixing hole 731, an axial fixing force between the shaft barrel 722 and the frame 73 is relatively weak thereof, the shaft barrel 722 may be likely to come off from the frame 73.

Moreover, since the penetrating shaft 71 penetrates from an end of the bushing 72 without the frame 721, after the louver blade 74 is assembled with the frame 73, the rear section 713 of the penetrating shaft 71 is located within the frame 73, such that the penetrating shaft 71 cannot be taken out of the bushing 72. If either the penetrating shaft 71 or the bushing 72 is damaged and needs to be replaced, one may have to disassemble and take out the penetrating shaft 71 together with the bushing 72 from the frame 73 and the louver blade 74 first before proceeding the replacement job. In addition, during the disassembling process, the penetrating shaft 71 and the bushing 72 may have chance of getting damaged and need to be replaced altogether, causing unexpected wastes and excessive cost on spare part purchase

Another structure is disclosed in U.S. Pat. No. 6,655,091, entitled “Shutter assembly”, as shown in FIG. 7, in which a stud shaft set is disposed between a louver blade 81 and a frame 82. The stud shaft set includes a bushing 83 and a stud shaft 84, and the stud shaft 84 has an insertion nail 841 and a sleeve 842. A washer 843 is disposed between the insertion nail 841 and the sleeve 842, and a plurality of flanges (not shown) is formed at an outer edge of the insertion nail 841, for being nailed into the louver blade 81. An outer diameter of the sleeve 842 is matched with an inner hole 831 of the bushing 83, a hole 845 is disposed at an end of the sleeve 842 away from the insertion nail 841, such that after the sleeve 842 is inserted into the bushing 83, a pin 85 is nailed into the hole 845, and thus the sleeve 842 is expanded to be tightly fitted with the bushing 83. Moreover, a plurality of fins 832 is formed at the outer edge of the bushing 83, for being snapped and positioned into a fixing hole 821 of the frame 82.

In such a structure, the bushing 83 can only be inserted into the fixing hole 821 of the frame 82 and snapped and positioned therein after the bushing 83 is combined with the stud shaft 84 through first inserting the sleeve 842 of the stud shaft 84 into the bushing 83 and then nailing the pin 85 into the hole 845 at the end of the sleeve 842. However, since the bushing 83 is a cylindrical-shaped structure, the fixing hole 821 on the frame 82 must be sized to the outer diameter of the bushing 83, so as for the bushing 83 to be easily inserted into the fixing hole 821. The corresponding relations among the stud shaft, the bushing, and the fixing hole of the frame in this structure are similar to that in the P.R.China Published Patent No. 2,525,224Y entitled “Louver blade positioning structure for shutter assembly”, that is to say, if the aperture of the fixing hole is too small, it is difficult for the louver blade to be assembled and rotated, and if the aperture of the fixing hole is relatively large, the loose problem tends to occur for the bushing.

With reference to U.S. Pat. No. 6,848,213, entitled “Louver mechanism for shutter”, as shown in FIG. 8, in such a mechanism, a rack 92 is extended for a predetermined length within a frame 91, a rack lever 93 is disposed in the rack 92, and the rack lever 93 has a gear 931, a middle section 932, and a pin portion 933. The gear 931 is engaged with the rack 92, and the pin portion 933 is inserted into a hole 941 of a louver blade 94, and a spline structure 934 is disposed between the middle section 932 and the pin portion 933, for snapping and positioning the louver blade 94. Therefore, when the rack 92 is driven to move up and down in the frame 91, it drives the rack lever 93 and the louver blade 94 to pivotally rotate, changing the angle of the louver blade 94 between the open and closed positions.

Straight flanges 921 are respectively disposed at both sides of the rack 92 for accommodating the gear 931 therein, and the gear 931 has a collar 935 at an end opposite to the middle section 932. A diameter of the collar 935 is greater than the outer diameter of the gear 931, and matches with the gap between the flanges 921 at both sides of the rack 92, such that the gear 931 keeps a certain distance away from the flanges 921 at both sides, and merely the collar 935 is in contact with the two straight flanges 921, thereby reducing the contact area to avoid unnecessary frictions, and thus the rack lever 93 and louver blade 94 are easily driven by the rack 92 to rotate pivotally.

In the above mechanism, a structure capable of reducing the contact area to avoid unnecessary frictions and enabling the louver blade 94 to be easily rotated pivotally is disclosed. However, such a structure is formed by the collar 935 and two straight flanges 921, and thus cannot be directly applied to the structures mentioned in P.R.China Published Patent No. 2,525,224Y and U.S. Pat. No. 6,655,091 to solve the problem of rotating the louver blade.

Therefore, how to generate a firmly gripping force between the bushing 83 (the bushing 72) and the fixing hole of the frame, and to maintain a suitable tightening and interfitting relation between the stud shaft 84 (the penetrating shaft 71) and the bushing 83 (the bushing 72) to make the louver blade be easily rotated, has become an urgent issue to be solved in the present invention.

### SUMMARY OF THE INVENTION

Accordingly, the present invention is directed to a rotating shaft of louver blades for shutter assembly, in which a plurality of slots is formed at an end of a bushing, such that the bushing can be flexibly deformed. After the shaft penetrates through the bushing, the shaft bears against the external expansion force of the bushing, such that the bushing is firmly snapped within a frame, and a proper interfitting relationship is maintained between the shaft and the bushing, making the louver blade be easily rotated.

Another object of the present invention is that, the shaft penetrates through a hole of the bushing from an end of the bushing close to the louver blade, such that the shaft can still be taken out of the bushing after the bushing is combined with the frame, which is convenient for maintenance and repair process.

In order to achieve the above objects, the present invention provides a rotating shaft, which includes a bushing and a shaft. A hole penetrates through a body of the bushing, and a plurality of slots is disposed at an end of the body, each slot extends for a predetermined distance from an end surface of the body along an axial direction of the hole, and each slot penetrates through the body in a radial direction. The shaft has a front section and a rear section, the front section is tightly fitted with the hole of the bushing, and the rear section is combined with the louver blade.

Due to the plurality of slots disposed at an end of the bushing, the bushing is capable of being deformed flexibly, and after the bushing is combined with the frame, as the fixing hole of the frame is relatively small, the end of the bushing having the slots is compressed inwards due to the flexible deformation. After the front section of the shaft penetrates through the bushing, the flexibly deformed portion is slightly expanded, such that the bushing is firmly inserted within the frame. Correspondingly, the flexibly deformed portion generates a clipping force to a part of the front section of the shaft, such that the shaft is tightly interfitted with the bushing, making the louver blade be easily rotated.

Moreover, the shaft penetrates through the hole from an end of the body of the bushing close to the louver blade, and thus if any one of the bushing and the shaft is damaged and needs to be replaced, the maintenance and repair process can be performed merely by disassembling and separating the louver blade from the frame, such that the shaft and the bushing can be disassembled and to be replaced, which is quite convenient.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is an exploded perspective view of the present invention;

FIG. 2 is an exploded perspective view of a rotating shaft according to the present invention;

FIG. 3 is a schematic sectional view of the bushing inserted into the fixing hole of the frame according to the present invention;

FIG. 4 is a schematic sectional view of the bushing combined with the shaft and the frame according to the present invention;

FIG. 5 is a combined schematic section view of the present invention;

FIG. 6 is a schematic sectional structural view of a first prior art arrangement;

FIG. 7 is a schematic sectional structural view of another prior art arrangement; and

FIG. 8 is a schematic sectional structural view of yet another prior art arrangement.

### DETAILED DESCRIPTION OF THE INVENTION

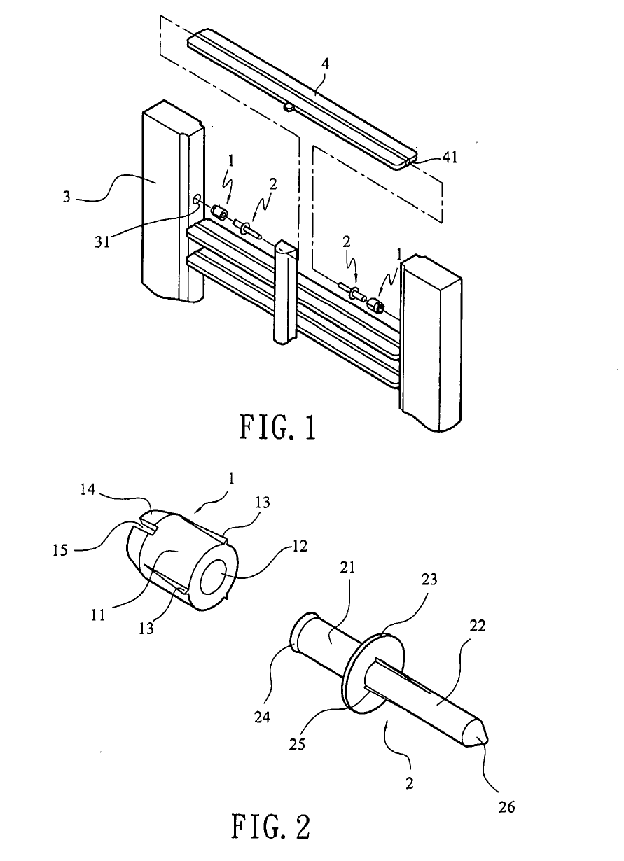

Referring to FIGS. 1 to 5, a structure of a first preferred embodiment of the present invention is shown.

As shown in FIGS. 1 and 2, the rotating shaft of the present invention is connected between a frame 3 and a louver blade 4, and the rotating shaft includes a bushing 1 and a shaft 2. The bushing 1 is utilized to insert into a fixing hole 31 of the frame 3, and the shaft 2 is utilized to combine with the bushing 1 and a corresponding fixing hole 41 of the louver blade 4.

The bushing 1 has a body 11, and a hole 12 penetrating through the body 11. The body 11 is of cylindrical-shaped, and a plurality of lugs 13 spaced apart in equidistance intervals is protruded from an exterior surface of the body 11.

A clipping portion 14 is disposed at an end of the body 11, and has a guide angle at an outer edge thereof, such that the end away from the body 11 has a smaller outer diameter than the diameter of the body 11 of the bushing 1. The clipping portion 14 has a plurality of slots 15, and each slot 15 extends for a predetermined distance from an exterior end surface of the clipping portion 14 along an axial direction of the hole 12, and penetrates through the clipping portion 14 in a radial direction.

The shaft 2 has a front section 21 and a rear section 22, and a stopper 23 is disposed between the front section 21 and the rear section 22, and the outer diameter of the stopper 23 is greater than the diameter of the hole 12 of the body 11, such that when the shaft 2 is being inserted into and combined with the bushing 1, the stopper 23 presses against the body 11 of the bushing 1 to be positioned.

The outer diameter of the front section 21 is smaller than the inner diameter of the hole 12 of the bushing 1, and a protrusion 24 with a larger outer diameter than that of the front section 21 is disposed at an end of the front section 21 corresponding to the clipping portion 14.

A plurality of fins 25 spaced apart in equidistance intervals is protruded from the exterior surface of the rear section 22 of the shaft 2, and a cone-shaped tip 26 is disposed at an end of the rear section 22 away from the front section 21.

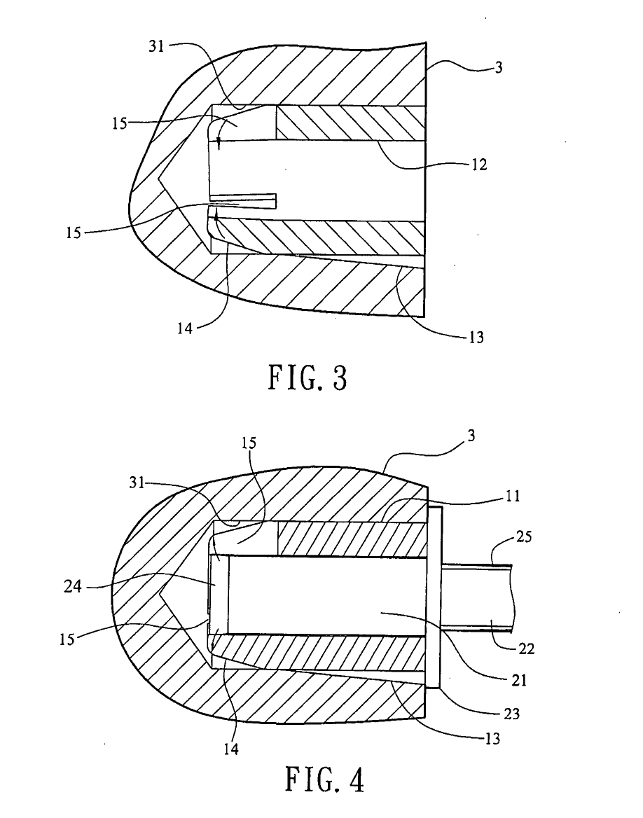

Referring to FIG. 3, in order to firmly combine the bushing 1 into the fixing hole 31 of the frame 3, the fixing hole 31 of the frame 3 is sized to receive the body 11 of the bushing 1. As the clipping portion 14 of the bushing 1 has a guide angle, and the clipping portion 14 has the plurality of slots 15, although the aperture of the fixing hole 31 is relatively small, the bushing 1 can still be easily inserted into the fixing hole 31 under the guidance of the guide angle and the inward compressing effect generated by the flexible deformation of the clipping portion 14.

Furthermore, the inner diameter of the fixing hole 31 is smaller than the outer diameter of the body 11, and thus when the bushing 1 is inserted into the fixing hole 31, the clipping portion 14 is flexibly deformed to compress inwards, as shown in FIG. 3. When the front section 21 of the shaft 2 is inserted into the hole 12 of the body 11, the protrusion 24 of the front section 21 expands and pushes the compressed clipping portion 14 outwards, such that the clipping portion 14 is stretched outwards to firmly press against an inner edge of the fixing hole 31, and embedded into the frame 3 through the lugs 13 of the body 11, and thus, the bushing 1 can be firmly snapped and positioned therein with the frame 3, as shown in FIG. 4.

Meanwhile, the clipping portion 14 also generates a force for clipping the front section 21 of the shaft 2, and due to the protrusion 24 at the front end of the front section 21, the clipping force generated by the clipping portion 14 is merely applied to the protrusion 24. Even if the clipping portion 14 generates a relative large clipping force, it does not influence the smoothness for the rotations of the shaft 2 and the louver blade 4 due to the limited interacting area, and meanwhile a suitable friction force is retained, such that the louver blade 4 can be positioned after it is rotated to a desired angle.

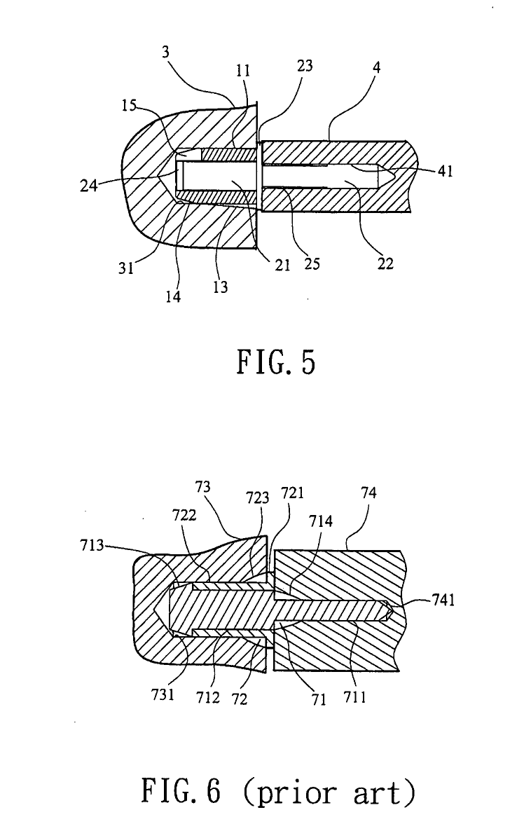

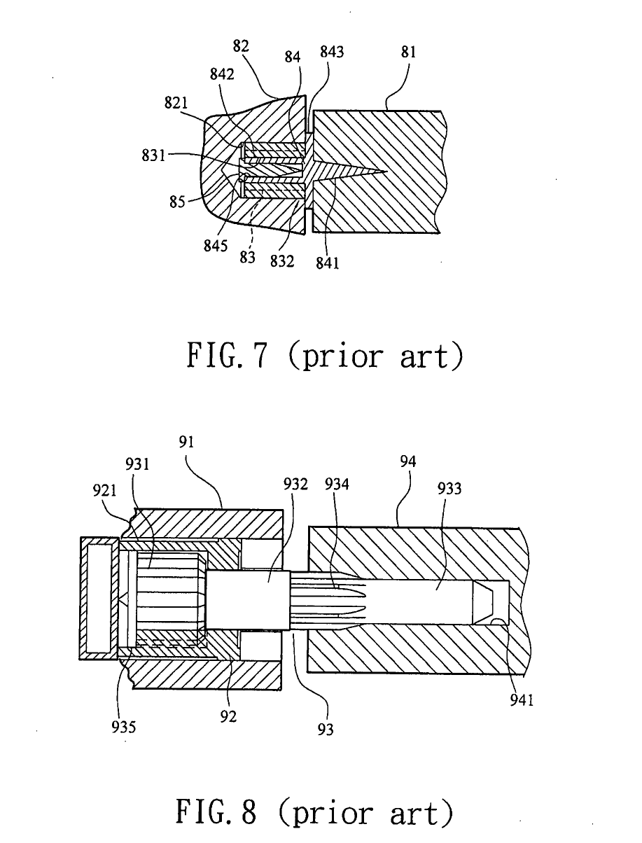

When the rear section 22 of the shaft 2 is inserted into the fixing hole 41 of the louver blade 4, the tip 26 of the rear section 22 can guide the rear section 22 to enter into the fixing hole 41 and to be inserted into the louver blade 4 through the plurality of fins 25 protruded from the outer surface of the rear section 22, such that the rear section 22 of the shaft 2 is snapped and positioned with respect to the louver blade 4. After the bushing 1, the shaft 2, the frame 3, and the louver blade 4 are combined and fixed, as shown in FIG. 5, the stopper 23 presses against the body 11 as a positioning member for inserting and positioning the shaft 2 into the bushing 1, so as to form a barrier between the louver blade 4 and the frame 3, thereby preventing the louver blade from interfering with the frame, and thus the louver blade can be readily and smoothly rotated.

Furthermore, the clipping portion 14 is capable of being flexibly deformed, and which is further capable of clamping the protrusion 24 through the flexible deformation effect to generate an ever-increasing tightness interfitting effect, and thus even though the external environmental condition and temperature are changed, the clipping portion 14 can still clip the protrusion 24 through the flexible deformation capability, so as to provide sufficient friction level when the shaft 2 is rotated relative to the bushing 1, ensuring the positioning effect of the louver blade 4.

Moreover, the protrusion 24 disposed thereon the shaft 2 is inserted into the hole 12 from the opposite end of the clipping portion 14 of the body 11 of the bushing 1, and the protrusion 24 of the shaft 2 is clamped against the inner edge of the clipping portion 14 of the bushing 1. Therefore, if one of the bushing 1 or the shaft 2 is damaged and needs to be replaced, the shaft 2 and the bushing 1 can be separated merely by disassembling the louver blade 4 from the frame 3, the bushing 1 is still combined in the frame 3, and the shaft 2 is still combined on the louver blade 4, and then the damaged bushing 1 or shaft 2 can be detached to be replaced, instead of replacing both the bushing and the shaft as that in the prior art, thereby avoiding unnecessary wastes and spare part purchase cost, and making the maintenance and repair jobs easier.

Of course, besides being disposed on the body of the bushing, the above slot structure can also be disposed at the rear section of the shaft, so as to enable the rear section of the shaft to have the flexible deformation capability, ensuring the snapping and positioning effects therebetween the rear section of the shaft and the louver blade.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rotating shaft of louver blades for shutter assembly, interconnected between a louver blade and a frame, comprising:
a bushing, having a body for being combined to the frame, a hole penetrating through the body, and a plurality of slots disposed at an end of the body, wherein each slot extends for a predetermined distance along an axial direction of the hole from an end surface of the body, and each slot penetrates through the hole from an exterior surface of the body; and
a shaft, having a front section and a rear section, wherein the front section is tightly fitted with the hole of the bushing, and the rear section is combined to the louver blade.

2. The rotating shaft of louver blades for shutter assembly as claimed in claim 1, wherein a stopper is disposed between the front section and the rear section of the shaft, and an outer diameter of the stopper is greater than a diameter of the hole in the body of the bushing.

3. The rotating shaft of louver blades for shutter assembly as claimed in claim 1, wherein a clipping portion is formed at slot ends of the bushing, and the clipping portion has a guide angle, such that an outer diameter of an end of the clipping portion away from the body is smaller than a diameter of the body of the bushing.

4. The rotating shaft of louver blades for shutter assembly as claimed in claim 1, wherein a plurality of lugs spaced apart in equidistant intervals is protruded from an exterior surface of the body.

5. The rotating shaft of louver blades for shutter assembly as claimed in claim 2, wherein a plurality of lugs spaced apart in equidistant intervals is protruded from an exterior surface of the body.

6. The rotating shaft of louver blades for shutter assembly as claimed in claim 1, wherein a plurality of fins spaced apart in equidistant intervals is protruded from an exterior surface of the rear section of the shaft.

7. The rotating shaft of louver blades for shutter assembly as claimed in claim 2, wherein a plurality of fins spaced apart in equidistant intervals is protruded from an exterior surface of the rear section of the shaft.

8. The rotating shaft of louver blades for shutter assembly as claimed in claim 1, wherein a protrusion with a larger outer diameter than that of the front section is disposed at an end of the front section away from the rear section.

9. The rotating shaft of louver blades for shutter assembly as claimed in claim 1, wherein a cone-shaped tip is disposed at an end of the rear section of the shaft away from the front section.

10. The rotating shaft of louver blades for shutter assembly as claimed in claim 1, wherein a plurality of slots is disposed at an end of the rear section of the shaft away from the front section, and each slot penetrates through the rear section in a radial direction.

11. The rotating shaft of louver blades for shutter assembly as claimed in claim 1, wherein the body of the bushing is of a cylindrical shape.
